(19) United States
(12) Patent Application Publication
(10) Pub. No.: US 2015/0147802 A1
(43) Pub. Date: May 28, 2015

(54) CLEANING AGENT COMPOSITION FOR MEDICAL-INSTRUMENT CLEANER

(71) Applicant: KAO CORPORATION, Tokyo (JP)

(72) Inventor: Masaya Nishio, Wakayama-shi (JP)

(73) Assignee: KAO CORPORATION, Tokyo (JP)

(21) Appl. No.: 14/404,388

(22) PCT Filed: May 28, 2013
(86) PCT No.: PCT/JP2013/064791

§ 371 Date: Nov. 26, 2014

(30) Foreign Application Priority Data
May 28, 2012 (JP) 2012-121400

(51) Int. Cl. C11D 1/835; C11D 3/386; C11D 11/00

(52) U.S. Cl. CPC C11D 1/835; C11D 11/0023; C11D 3/386
USPC 435/264; 134/10; 510/161

(57) ABSTRACT

The present invention relates to [1] a detergent composition for a washer for medical devices, including a nonionic surfactant (A) represented by the following formula (1), at least one compound (B) selected from the group consisting of fatty acids having not less than 6 and not more than 10 carbon atoms or salts thereof, a cationic surfactant (C) represented by the specific formula, and water; and [2] a method of washing a medical device using a washer for medical devices which includes the step of washing the medical device with a mixture including the above detergent composition and an enzyme. The present invention provides a detergent composition for a washer for medical devices which is less foamed even when used at a low temperature and is excellent in washability and storage stability, and a method of washing a medical device using a washer for medical devices,

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently a number of not less than 1 and not more than 20; and the mark “/” represents that EO and PO may be added either in a random form or in a block form, and an order of addition of EO and PO is optional.

### FIELD OF THE INVENTION

The present invention relates to detergent compositions for a washer for medical devices, and a method of washing a medical device using a washer for medical devices.

### BACKGROUND OF THE INVENTION

In recent years, there is an increasing tendency that medical devices for operations and various medical activities become disposable from the viewpoint of prevention of infection. However, on the contrary, it is considered that a demand for reusable medical devices will be increased in future because of expensiveness of the medical devices, reduction of wastes and easiness of use. Since various infectious stains such as blood, humor, gastric juice, saliva and cell pieces are adhered to the medical devices used for medical examination and treatment, the medical devices must be cleaned to surely remove the stains therefrom before subjected to subsequent medical examination and treatment.

Hitherto, the medical devices after used have been fully washed and disinfected before subjected to subsequent treatments. As an apparatus for washing the medical devices, there is known an automatic washing machine such as a washer/disinfector. However, in order to ensure a washing operation of the medical devices, it has been always required to previously manually wash the medical devices before washed using the automatic washing machine.

In particular, there are present only a limited number of methods for sterilizing a specific medical device such as an endoscope, and it has been therefore demanded to provide a method capable of surely washing such a medical device.

Patent Literature 1 aims at providing a surfactant suitably used for spraying which exhibits a low foamability over a temperature range of from 15 to 80° C., and discloses an industrial cleaner containing a quaternary ammonium compound and an alkyl(alkenyl)polyethylene glycol mixed ether at specific ratios, and further containing a fatty acid, and a reaction product of a fatty alcohol with ethyleneoxide and propyleneoxide.

Patent Literature 2 aims at providing a detergent for metals which exhibits a high washability for metals and is excellent in rust preventive property, waste water-treating property, foam-suppressing property and liquid stability, and discloses a detergent for metals which contains a polyoxyalkylene alkyl ether, an aliphatic carboxylic acid and a nitrogen-containing organic compounds such as diallyl dimethyl ammonium chloride.

Patent Literature 3 aims at improving a detergency and a defoaming property, and discloses a detergent composition for floors which contains an anionic surfactant, a cationic surfactant, a nonionic surfactant and a glycol ether-based solvent at specific ratios.

Patent Literature 4 aims at improving a detergency, and discloses a detergent composition for medical devices which contains a low-foaming nonionic surfactant, an alkanol amine and an alkaline protease at specific concentrations.

Patent Literature 5 aims at improving a detergency and a softening property, and discloses a liquid detergent composition containing a specified two classes of polyoxyalkylene alkyl ether-type nonionic surfactant, an alkylbenzene sulfonic acid or a salt thereof, a specific cationic surfactant and a specific fatty acid or a salt thereof at specific ratios.

Patent Literature 6 aims at improving a formability and a rinsing property, and discloses a liquid detergent composition containing a specific quaternary ammonium salt-type cationic surfactant, a specific carboxylic acid salt-type anionic surfactant and a specific alkyl polyglycoside having an average monosaccharide condensation degree of from 1 to 3 at specific ratios.

Patent Literature 7 aims at improving a washing performance, a low foamability and a storage stability, and discloses a liquid detergent composition containing a sequestering agent, a nonionic surfactant, a cationic surfactant, an organic electrolyte high-molecular weight polymer, an alkyl aliphatic dicarboxylic acid salt or the like at specific ratios, but containing no alkaline agent.

### CITATION LIST

### Patent Literatures

Patent Literature 1: JP 5-506689A

Patent Literature 2: WO 2011/105449A

Patent Literature 3: JP 2001-247892A

Patent Literature 4: JP 2009-144070A

Patent Literature 5: JP 11-315299A

Patent Literature 6: JP 2005-290049A

Patent Literature 7: JP 2002-146400A

### SUMMARY OF THE INVENTION

Thus, the present invention relates to the following aspects [1] and [2].

[1] A detergent composition for a washer for medical devices, including a nonionic surfactant (A) represented by the formula (1) which is contained in the composition in an amount of not less than 1% by mass and not more than 40% by mass; at least one compound (B) selected from the group consisting of fatty acids having not less than 6 and not more than 10 carbon atoms and salts thereof which is contained in the composition in an amount of not less than 1% by mass and not more than 20% by mass in terms of a fatty acid; a cationic surfactant (C) represented by the formula (2); and water,

the nonionic surfactant (A) being present in an amount of not less than 90% by mass on the basis of a total amount of whole nonionic surfactants contained in the detergent composition,

a mass ratio of the at least one compound (B) selected from the group consisting of fatty acids having not less than 6 and not more than 10 carbon atoms and salts thereof to the cationic surfactant (C) [(B)/(C)] being not less than 20 and not more than 3000, and

the detergent composition having a pH value of not less than 10 as measured at 25° C.,

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently is a number of not less than 1 and not more than 20; and the mark “/” represents that EO and PO may be added either in a random form or in a block form, and an order of addition of EO and PO is optional, and

N⁺(R¹)(R²)(R³)(R⁴).X⁻ (2)

wherein R¹, R², R³ and R⁴ are each independently an alkyl group having not less than 1 and not more than 24 carbon atoms or a benzyl group; and X⁻ is a monovalent anion; and
[2] A method of washing a medical device using a washer for medical devices including the step of washing the medical device with a mixture including the detergent composition for a washer for medical devices as described in the above [1], and an enzyme.

### DETAILED DESCRIPTION OF THE INVENTION

Upon cleaning medical devices using an automatic washer, there have been used various methods such as high-pressure showering, high-pressure water stirring, ultrasonic washing, etc. However, these methods are very likely to cause foaming of a washing solution. Once foaming occurs, there tends to be caused such a concern that foams thus generated weaken the water flow or ultrasonic wave, leading to deterioration in detergency.

In ordinary cleaning application fields such as dish washing, as the temperature upon washing is raised, the detergency becomes higher. However, since stains attached to medical devices are composed mainly of proteins such as bloods, a higher washing temperature contrarily tends to cause denaturation of the proteins, so that the stains tend to be hardly removed from the medical devices. For this reason, when washing the medical devices, a washing solution therefor has been often used without heating. In particular, when cleaning an endoscope using an endoscope washer, it is general to wash the endoscope without heating the washing solution. Also, upon cleaning the medical devices, water having a very low hardness such as ion-exchanged water and RO water (reverse osmosis membrane-treated water) has been used to enhance a detergency of the washing solution.

However, as the washing temperature is lowered or the hardness of water fed is reduced, foaming is likely to be caused, so that there tends to occur such a concern that a washing performance of the automatic washer is deteriorated.

In addition, if a strong physical force is applied to the washing solution to enhance a detergency, foaming is likely to occur. Once foaming occurs, the physical force such as ultrasonic wave and water flow tends to no longer act on the medical devices, thereby causing such a concern that the detergency tends to be contrarily deteriorated. Also, in the winter season, tap water or ground water tends to be chilled to about 5° C. Under such conditions, even detergents that are free from foaming at a high temperature or substances used as a foam suppressor tend to cause foaming of the washing solution.

Further, drugs used upon operations or medical inspections, or residual drugs used in preliminary cleaning, i.e., so-called carry-over drugs, which remain attached onto the medical devices, tend to often accelerate foaming to a considerable extent.

As described above, conditions of washing the medical devices by an automatic washer are quite different from those used in a dishwater or other automatic washers ordinarily using a warm water, i.e., the medical devices tend to be washed in the automatic washer under the condition that foaming is very likely to occur. Therefore, the detergents used for washing the medical devices in the automatic washer require foam-suppressing techniques that are quite different from those for detergents used in the other applications.

The detergents described in Patent Literature 1 are used in spray cleaning facilities employed in automobile industries, and tend to suffer from considerable foaming if used in a washer for medical devices.

The detergents described in Patent Literature 2 are metal detergents used for washing metal parts machined, and tend to suffer from considerable foaming if used in a washer for medical devices.

The detergents described in Patent Literature 3 are floor detergents, and tend to suffer from considerable foaming if used in a washer for medical devices.

The detergents described in Patent Literature 4 tend to suffer from considerable foaming owing to inclusion of drugs used upon endoscope inspections.

The detergents described in Patent Literature 5 are clothing detergents, and tend to suffer from considerable foaming when exposed to a very strong physical force, e.g., when used in a washer for medical devices, and therefore become unusable in such a washer.

The detergents described in Patent Literature 6 are characterized by a high foaming power, and tend to suffer from considerable foaming if used in a washer for medical devices, and become unusable in such a washer.

The detergents described in Patent Literature 7 which contain no alkaline agent tend to be insufficient in not only detergency required as detergents for medical devices but also foam-suppressing property upon washing.

The present invention provides a detergent composition for a washer for medical devices which can be inhibited from foaming even when residual drugs, i.e., carry-over drugs used in medical inspections, etc., are present on the medical devices to be washed by an automatic washer, and can exhibit an excellent washability, and a method of washing a medical device using a washer for medical devices.

The present invention relates to the following aspects [1] and [2].

[1] A detergent composition for a washer for medical devices, including a nonionic surfactant (A) represented by the following formula (1) which is contained in the composition in an amount of not less than 1% by mass and not more than 40% by mass; at least one compound (B) selected from the group consisting of fatty acids having not less than 6 and not more than 10 carbon atoms and salts thereof which is contained in the composition in an amount of not less than 1% by mass and not more than 20% by mass in terms of a fatty acid; a cationic surfactant (C) represented by the following formula (2); and water,

the nonionic surfactant (A) being present in an amount of not less than 90% by mass on the basis of a total amount of whole nonionic surfactants contained in the detergent composition,

a mass ratio of the at least one compound (B) selected from the group consisting of fatty acids having not less than 6 and not more than 10 carbon atoms and salts thereof to the cationic surfactant (C) [(B)/(C)] being not less than 20 and not more than 3000, and

the detergent composition having a pH value of not less than 10 as measured at 25° C.,

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently is a number of not less than 1 and not more than 20; and the mark “/” represents that EO and PO may be added either in a random form or in a block form, and an order of addition of EO and PO is optional, and

N⁺(R¹)(R²)(R³)(R⁴).X⁻ (2)

wherein R¹, R², R³ and R⁴ are each independently an alkyl group having not less than 1 and not more than 24 carbon atoms or a benzyl group; and X⁻ is a monovalent anion; and
[2] A method of washing a medical device using a washer for medical devices including the step of washing the medical device with a mixture including the detergent composition for a washer for medical devices as described in the above [1], and an enzyme.

According to the present invention, there are provided a detergent composition for a washer for medical devices which can be inhibited from foaming even when residual drugs, i.e., carry-over drugs used in medical inspections, etc., are present on the medical devices to be washed by an automatic washer and can exhibit excellent washability and storage stability, and a method of effectively washing a medical device using a washer for medical devices.

The detergent composition for a washer for medical devices according to the present invention includes a nonionic surfactant represented by the above formula (1) which is contained in the composition in an amount of not less than 1% by mass and not more than 40% by mass, at least one compound selected from the group consisting of fatty acids having not less than 6 and not more than 10 carbon atoms and salts thereof which is contained in the composition in an amount of not less than 1% by mass and not more than 20% by mass in terms of a fatty acid, a cationic surfactant represented by the above formula (2), and water. The detergent composition of the present invention is characterized in that the nonionic surfactant represented by the above formula (1) is present in an amount of not less than 90% by mass on the basis of a total amount of whole nonionic surfactants contained in the detergent composition; the mass ratio of the at least one compound (B) selected from the group consisting of fatty acids having not less than 6 and not more than 10 carbon atoms and salts thereof to the cationic surfactant (C) [(B)/(C)] is not less than 20 and not more than 3000; and the pH value of the detergent composition is not less than 10 as measured at 25° C. The detergent composition of the present invention can be inhibited from foaming even when residual drugs, i.e., carry-over drugs, which are used in medical inspections, etc., are present on the medical devices to be washed in a washer for medical devices, and can exhibit an excellent washability. The reason why the detergent composition of the present invention has these advantageous effects is considered as follows, although not clearly determined.

In general, a fatty acid or a salt thereof is compounded in a detergent composition in order to solubilize a nonionic surfactant generally used as a detergent component thereof. When a cationic surfactant is further added to the detergent composition in order to suppress foaming, the cationic surfactant is associated with the nonionic surfactant and the fatty acid salt to form a complex thereof, so that the resulting composition tends to be deteriorated in storage stability. However, in the case where a specific amount of a nonionic surfactant having a specific structure, a specific amount of a cationic surfactant having a specific structure and a fatty acid salt having a specific structure are compounded, and the mass ratio between the fatty acid salt and the cationic surfactant [(B)/(C)] is controlled to a specific range, the bond between the fatty acid salt and the cationic surfactant in their complex tends to be weakened, so that the fatty acid salt and the cationic surfactant are partially solubilized in the nonionic surfactant while being kept in the complex form and stably present in the solution, and on the other hand, the fatty acid salt and the cationic surfactant are partially present in respective individual forms. The complex form and individual form are present in an equilibrium state, so that the resulting detergent composition can exhibit both properties of the complex and properties of the individual surfactants at the same time. For this reason, the detergent composition of the present invention can be enhanced in foam-suppressing property upon washing and is allowed to be present in a stable condition. Further, is has been unexpectedly found that when the mass ratio [(B)/(C)] lies within such a specific range, even if an anionic surfactant that tends to cause considerable foaming even in a small amount is included in the composition owing to carry-over of test drugs, etc., the cationic surfactant forms a complex with the anionic surfactant in place of the fatty acid salt, so that it is possible to suppress foaming of the anionic surfactant thus included.

### [Detergent Composition for Washer for Medical Devices]

The detergent composition for a washer for medical devices according to the present invention (hereinafter also referred to merely as a “detergent composition”) includes a nonionic surfactant (A) represented by the following formula (1) (hereinafter also referred to merely a “nonionic surfactant (A)” or a “component (A)”) which is contained in the composition in an amount of not less than 1% by mass and not more than 40% by mass:

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently is a number of not less than 1 and not more than 20; and the mark “I” represents that EO and PO may be added either in a random form or in a block form, and an order of addition of EO and PO is optional,

at least one compound (B) selected from the group consisting of fatty acids having not less than 6 and not more than 10 carbon atoms and salts thereof (hereinafter also referred to merely “a fatty acid or a salt thereof (B)” or a “component (B)”) which is contained in the composition in an amount of not less than 1% by mass and not more than 20% by mass in terms of a fatty acid,

a cationic surfactant (C) represented by the following formula (2) (hereinafter also referred to merely as a “cationic surfactant (C)” or a “component (C)”):

N⁺(R¹)(R²)(R³)(R⁴).X⁻ (2)

wherein R¹, R², R³ and R⁴ are each independently an alkyl group having not less than 1 and not more than 24 carbon atoms or a benzyl group; and X⁻ is a monovalent anion, and
water.

The nonionic surfactant (A) is present in an amount of not less than 90% by mass on the basis of a total amount of whole nonionic surfactants contained in the detergent composition.

The mass ratio [(B)/(C)] is not less than 20 and not more than 3000.

The detergent composition has a pH value of not less than 10 as measured at 25° C.

Meanwhile, the expression “containing a fatty acid or a salt thereof” as used in the present specification also means the case where both the fatty acid and the salt thereof are contained.

In addition, from the viewpoints of suppressing foaming and enhancing a detergency, the detergent composition according to the present invention preferably further contains an alkaline agent (D).

In the following, the respective components of the detergent composition according to the present invention are described.

### <Nonionic Surfactant (A) Represented by the Following Formula (1)>

The detergent composition according to the present invention contains a nonionic surfactant (A) represented by the following formula (1) as a component (A):

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently is a number of not less than 1 and not more than 20; and the mark “/” represents that EO and PO may be added either in a random form or in a block form, and an order of addition of EO and PO is optional.

In the present invention, the number of carbon atoms in R in the formula (1) is not less than 6 and preferably not less than 8, and is also not more than 18, preferably not more than 12 and more preferably not more than 10 from the viewpoints of a good washability upon washing a medical device using a washer for medical devices and a good foam-suppressing property upon the washing.

The alkyl group having not less than 6 and not more than 18 carbon atoms as R in the formula (1) may be either a linear-chain alkyl group or a branched-chain alkyl group, and is preferably a branched-chain alkyl group from the viewpoints of a good washability and a good foam-suppressing property upon washing.

From the viewpoints of a good washability and a good foam-suppressing property upon washing, R in the formula (1) is preferably a branched-chain alkyl group having not less than 6 and not more than 18 carbon atoms, more preferably a branched-chain alkyl group having not less than 8 and not more than 12 carbon atoms, and still more preferably a branched-chain alkyl group having not less than 8 and not more than 10 carbon atoms.

In the formula (1), the ethanediyloxy group represented by EO is preferably an ethane-1,2-diyloxy group from the viewpoints of a good washability and a good foam-suppressing property upon washing, and the propanediyloxy group represented by PO may be a propane-1,3-diyloxy group or a propane-1,2-diyloxy group, and is preferably a propane-1,2-diyloxy group from the viewpoints of a good washability and a good foam-suppressing property upon washing.

Also, from the viewpoint of suppressing foaming upon washing a medical device at a low temperature using a washer for medical devices, m in the formula (1) is not less than 1, preferably not less than 2, more preferably not less than 3, still more preferably not less than 4, even still more preferably not less than 5 and further even still more preferably not less than 5.8, and is also not more than 20, preferably not more than 15, more preferably not more than 10 and still more preferably not more than 9.

From the viewpoint of suppressing foaming upon low-temperature washing, n in the formula (1) is not less than 1, preferably not less than 3, more preferably not less than 4, still more preferably not less than 4.5 and even still more preferably not less than 4.8, and is also not more than 20, preferably not more than 10, more preferably not more than 7, still more preferably not more than 6 and even still more preferably not more than 5.2.

In the formula (1), EO and PO are preferably in the form of a random adduct from the viewpoint of a good foam-suppressing property.

The nonionic surfactant (A) represented by the formula (1) may be obtained by addition-polymerizing ROH (wherein R is the same as defined in the above formula (1)) with ethyleneoxide and propyleneoxide which are each added in a predetermined amount.

Many of the washers for medical devices, e.g., endoscope washers, are not controlled with respect to a temperature of water used therein upon washing. Therefore, even though there arises no significant foaming problem upon washing with normal temperature water or warm water, when using water having a low temperature (for example, 5° C.), there tends to occur such a concern that foams are hardly eliminated.

On the other hand, in the endoscope washer, water injected under a high pressure is always circulated through an inside thereof in order to enhance a detergency when washing an endoscope using the endoscope washer, so that foaming is more likely to occur therein.

Once the foaming occurs in the endoscope washer, a physical force such as an ultrasonic wave and a water flow is reduced owing to the foams produced and hardly propagated to a surface of the endoscope, which may result in not only deterioration in detergency, but also stopping of the washer owing to erroneous operation of a level sensor for sensing feed or discharge of a washing solution which is mounted in the endoscope washer. The same disadvantage tends to occur when using extremely low-hardness water such as RO water (reverse osmosis membrane-treated water) and ion-exchanged water.

For this reason, it is required to suppress foaming even in the case where low-hardness water (having, for example, a hardness of 1 ppm) is used in the endoscope washer.

Under such a condition that water has a low temperature (e.g., 5° C.) and a low hardness (e.g., a hardness of not less than 0 ppm and not more than 10 ppm), almost all of surfactants exhibit a high foamability, and therefore are unsuitable for the washing operation using the washer for medical devices such as the endoscope washer. On the other hand, many of surfactants having a very low foamability are also unsuitable for the washing operation using the washer for medical devices because they have an excessively low detergency.

In the detergent composition according to the present invention, the nonionic surfactant (A) is preferably used in a predetermined amount or more as the surfactant component except for the component (B) from the viewpoints of achieving both of less foaming at a low temperature and a good detergency. Further, if any surfactants other than the nonionic surfactant (A) as the surfactant component except for the component (B) are mixed even in a small amount in the detergent composition, much foaming tends to occur, and the detergent composition tends to be deteriorated in detergency. Therefore, a majority of the surfactants in the detergent composition is preferably constituted of the nonionic surfactant (A).

More specifically, the content of the nonionic surfactant (A) in the surfactants except for the fatty acid having not less than 6 and not more than 10 carbon atoms or the salt thereof as the component (B) is preferably not less than 90% by mass, more preferably not less than 95% by mass, and still more preferably not less than 98% by mass.

In the detergent composition of the present invention, the nonionic surfactant (A) is present in an amount of not less than 90% by mass, preferably not less than 95% by mass, more preferably not less than 98% by mass, still more preferably substantially 100% by mass, and even still more preferably 100% by mass on the basis of a total amount of whole nonionic surfactants contained in the detergent composition from the viewpoint of a good foam-suppressing property of the detergent composition upon washing.

The nonionic surfactant (A) usually has a low cloud point that lies in the range of not lower than 10° C. and not higher than 50° C. and therefore tends to be separated from water and become whitely turbid when used under a high temperature condition. Therefore, in the detergent composition of the present invention, different kinds of surfactants other than the component (A) may be used in combination with the nonionic surfactant (A). From the viewpoint of suppressing foaming of the detergent composition, the content of the surfactants other than the component (A) (except for the component (B)) is preferably not more than 10% by mass on the basis of a total amount of the whole surfactants contained in the detergent composition.

It is required that the content of the nonionic surfactant (A) in the detergent composition according to the present invention is not less than 1% by mass and not more than 40% by mass from the viewpoints of a good washability and a good foam-suppressing property upon washing. The content of the nonionic surfactant (A) in the detergent composition is preferably not less than 2% by mass, more preferably not less than 3% by mass and still more preferably not less than 4% by mass from the viewpoint of a good washability, and is also preferably not more than 20% by mass, more preferably not more than 10% by mass, still more preferably not more than 8% by mass and even still more preferably not more than 6% by mass from the viewpoint of a good foam-suppressing property upon washing.

<At Least One Compound (B) Selected from the Group Consisting of Fatty Acids Having not Less than 6 and not More than 10 Carbon Atoms and Salts Thereof>

The detergent composition according to the present invention contains at least one compound (B) selected from the group consisting of fatty acids having not less than 6 and not more than 10 carbon atoms and salts thereof (fatty acid or salt thereof (B)). In the present invention, by using the nonionic surfactant (A) in combination with the fatty acid or salt thereof (B) and the cationic surfactant (C), the resulting detergent composition can be improved in storage stability without any adverse influence on a foam-suppressing property and a washability thereof by the nonionic surfactant (A).

The number of carbon atoms in a fatty acid of the component (B) is preferably not less than 7 and more preferably not less than 8, and is also preferably not more than 9 and more preferably 9 from the viewpoints of a good storage stability of the detergent composition according to the present invention and a good foam-suppressing property thereof upon washing. In addition, from the viewpoints of a good storage stability of the detergent composition according to the present invention and a good foam-suppressing property thereof upon washing, the component (B) is preferably a branched-chain fatty acid and more preferably a saturated branched-chain fatty acid.

Examples of the fatty acid or salt thereof (B) include (i) linear-chain fatty acids such as n-hexanoic acid, n-heptanoic acid, n-octanoic acid (caprylic acid), n-nonanoic acid and n-decanoic acid, (ii) branched-chain fatty acids, e.g., isodecanoic acids such as methyl nonanoic acid, ethyl octanoic acid, dimethyl octanoic acid, trimethyl heptanoic acid, propyl heptanoic acid, butyl hexanoic acid and diethyl hexanoic acid; isononanoic acids such as methyl octanoic acid, ethyl heptanoic acid, dimethyl heptanoic acid, trimethyl hexanoic acid, propyl hexanoic acid and butyl pentanoic acid; isooctanoic acids such as methyl heptanoic acid, ethyl hexanoic acid and dimethyl hexanoic acid; isoheptanoic acids such as methyl hexanoic acid and ethyl pentanoic acid; and isohexanoic acids such as methyl pentanoic acid and ethyl butanoic acid, and salts of these acids. The salts may be in the form of an alkali metal salt such as a sodium salt and a potassium salt, or an alkali earth metal salt such as a calcium salt.

These fatty acids and salts thereof (B) may be used alone or in combination of any two or more thereof.

Of these components (B), from the viewpoints of a good storage stability of the detergent composition according to the present invention and a good foam-suppressing property thereof upon washing, preferred is at least one compound selected from the group consisting of n-octanoic acid, isooctanoic acids, isononanoic acids and alkali metal salts of these acids, more preferred is at least one compound selected from the group consisting of isooctanoic acids, isononanoic acids and sodium salts of these acids, still more preferred is at least one compound selected from the group consisting of 2-ethyl hexanoic acid, 3,5,5-trimethyl hexanoic acid and sodium salts thereof, and even still more preferred is at least one compound selected from the group consisting of 3,5,5-trimethyl hexanoic acid and sodium salts thereof.

From the viewpoints of a good storage stability of the detergent composition according to the present invention and a good foam-suppressing property thereof upon washing, it is required that the content of the fatty acid or salt thereof (B) in the detergent composition according to the present invention is not less than 1% by mass and not more than 20% by mass, and the content of the fatty acid or salt thereof (B) in the detergent composition is preferably not less than 2% by mass, more preferably not less than 3% by mass and still more preferably not less than 5% by mass, and is also preferably not more than 15% by mass, more preferably not more than 10% by mass and still more preferably not more than 7% by mass. Meanwhile, the content of the fatty acid salt as the fatty acid or salt thereof (B) is the value of a mass calculated in terms of a fatty acid.

From the viewpoints of a good storage stability of the detergent composition according to the present invention and a good foam-suppressing property thereof upon washing, the mass ratio of the content of the nonionic surfactant (A) to the content of the fatty acid or salt thereof (B) [(A)/(B)] is preferably not less than ⅕, more preferably not less than ⅓, still more preferably not less than 3/7, even still more preferably not less than ½ and further even still more preferably not less than 0.8, and is also preferably not more than 5, more preferably not more than 3, still more preferably not more than 2, even still more preferably not more than 1.4 and further even still more preferably not more than 1.2.

In the case where the surfactants contained in the detergent composition according to the present invention are the component (A) and the component (B) only, a trace amount of carry-over components attached to a medical device such as an endoscope may cause considerable foaming of a washing solution. More specifically, upon medical treatments using an endoscope in which a drug such as monoethanolamine oleate (“OLDAMIN FOR INJECTION” (tradename) available from Fuji Chemical Industry Co., Ltd.) is often used as a hemostatic agent, even when only 10 μL of the OLDAMIN FOR INJECTION is mixed in the detergent composition for a washer for medical devices which contains the component (A) and the component (B) only as the surfactants, monoethanolamine oleate contained in the OLDAMIN FOR INJECTION tends to be cause a very large influence on foaming upon washing. The occurrence of the similar phenomenon has been confirmed with respect to “GASCON DROP” (tradename; available from Kissei Pharmaceutical Co., Ltd.) as a mucosa defoaming agent and “BARITOP” (tradename; available from Kaigen Pharma Co., Ltd.) as a contrast agent. The carry-over components such as the monoethanolamine oleate, “GASCON DROP” and “BARITOP” all show a significant influence on foaming even when added in a very small amount. With respect to these drugs, it is considered that the surfactants added for dispersing effective ingredients in the drugs used upon endoscope inspections exhibit a significant influence on foaming.

### <Cationic Surfactant (C)>

The detergent composition according to the present invention contains a cationic surfactant in the form of a quaternary ammonium salt represented by the following formula (2), as a component (C):

N⁺(R¹)(R²)(R³)(R⁴).X⁻ (2)

wherein R¹, R², R³ and R⁴ are each independently an alkyl group having not less than 1 and not more than 24 carbon atoms or a benzyl group; and X⁻ is a monovalent anion.

From the viewpoint of a good foam-suppressing property, R¹ in the formula (2) is preferably an alkyl group having not less than 8 and not more than 16 carbon atoms, R² in the formula (2) is preferably an alkyl group having not less than 8 and not more than 16 carbon atoms or an alkyl group having not less than 1 and not more than 3 carbon atoms, R³ in the formula (2) is preferably an alkyl group having not less than 1 and not more than 3 carbon atoms or a benzyl group, and R⁴ in the formula (2) is preferably an alkyl group having not less than 1 and not more than 3 carbon atoms or a benzyl group.

X⁻ may be at least one ion selected from the group consisting of halide ions such as a fluoride ion, a chloride ion, a bromide ion and an iodide ion, a hydroxide ion, an acetate ion, a formate ion, a nitrate ion and a hydrogen carbonate ion. Of these ions, from the viewpoint of a good storage stability of the detergent composition according to the present invention, preferred is at least one ion selected from the group consisting of a hydroxide ion and halide ions, more preferred is at least one ion selected from the group consisting of halide ions, and still more preferred is a chloride ion.

Specific examples of the preferred cationic surfactant (C) include alkyl dimethyl benzyl ammonium halides such as octyl dimethyl benzyl ammonium chloride, decyl dimethyl benzyl ammonium chloride, dodecyl dimethyl benzyl ammonium chloride, dodecyl dimethyl benzyl ammonium bromide, tetradecyl dimethyl benzyl ammonium chloride, pentadecyl dimethyl benzyl ammonium chloride, hexadecyl dimethyl benzyl ammonium chloride and octadecyl dimethyl benzyl ammonium chloride; alkyl trimethyl ammonium halides such as octyl trimethyl ammonium chloride, octyl trimethyl ammonium bromide, decyl trimethyl ammonium chloride, dodecyl trimethyl ammonium chloride, tetradecyl trimethyl ammonium chloride, hexadecyl trimethyl ammonium chloride and octadecyl trimethyl ammonium chloride; dialkyl dimethyl ammonium halides such as dioctyl dimethyl ammonium chloride, didecyl dimethyl ammonium chloride, decylisononyl dimethyl ammonium chloride and didecyl dimethyl ammonium chloride; and alkyl pyridinium chlorides and tetraalkyl ammonium chlorides. Of these cationic surfactants (C), from the viewpoint of a good foam-suppressing property upon washing, preferred are alkyl dimethyl benzyl ammonium halides, and more preferred are alkyl dimethyl benzyl ammonium chlorides such as dodecyl dimethyl benzyl ammonium chloride, tetradecyl dimethyl benzyl ammonium chloride and hexadecyl dimethyl benzyl ammonium chloride.

These cationic surfactants may be used alone or in combination of any two or more thereof.

The content of the cationic surfactant (C) in the detergent composition according to the present invention is preferably not less than 0.0015% by mass, more preferably not less than 0.002% by mass, still more preferably not less than 0.0025% by mass, even still more preferably 0.005% by mass and further even still more preferably not less than 0.01% by mass, and is also preferably not more than 0.3% by mass, more preferably not more than 0.2% by mass, still more preferably not more than 0.1% by mass, even still more preferably not more than 0.05% by mass and further even still more preferably not more than 0.03% by mass from the viewpoint of a good foam-suppressing property.

The cationic surfactant (C) has a foam-suppressing effect. The foam-suppressing effect of the cationic surfactant (C) can be exhibited only when the content of the component (C) in the detergent composition for a washer for medical devices is very small. In general, the cationic surfactant (C) is frequently used as a bactericide. However, when using the cationic surfactant (C) at such a low concentration under the environmental condition in which the fatty acid or salt thereof coexists therewith, the cationic surfactant tends to be deactivated and exhibit no bactericidal effect. If the cationic surfactant (C) is used at such a high concentration as to exhibit a sufficient bactericidal effect, the cationic surfactant contrarily fails to exhibit a good foam-suppressing effect.

In the detergent composition according to the present invention, from the viewpoint of attaining a good foam-suppressing effect, the mass ratio of the content of the fatty acid or salt thereof (B) to the content of the cationic surfactant (C) [(B)/(C)] is important. The mass ratio [(B)/(C)] is not less than 20, preferably not less than 25, more preferably not less than 30, still more preferably not less than 50, even still more preferably not less than 100, further even still more preferably not less than 170 and further even still more preferably not less than 200, and is also not more than 3000, preferably not more than 2500, more preferably not more than 2000, still more preferably not more than 1000 and even still more preferably not more than 500.

In addition, in the detergent composition according to the present invention, from the viewpoint of attaining a good foam-suppressing effect, the mass ratio of the content of the nonionic surfactant (A) to the content of the cationic surfactant (C) [(A)/(C)] is preferably not less than 20, more preferably not less than 25, still more preferably not less than 30, even still more preferably not less than 50, further even still more preferably not less than 100, further even still more preferably not less than 170 and further even still more preferably not less than 200, and is also preferably not more than 3000, more preferably not more than 2500, still more preferably not more than 2000, even still more preferably not more than 1000 and further even still more preferably not more than 500.

### <Water>

The detergent composition according to the present invention contains water. The water used in the detergent composition may be either tap water, ion-exchanged water, RO water or distilled water. The water may be mixed with warm water or may be hincoreated to raise a temperature of the detergent composition according to the present invention. The hardness of the water is preferably not more than 200 ppm and more preferably not more than 100 ppm from the viewpoint of a good washability.

### <Alkaline Agent (D)>

The detergent composition according to the present invention preferably contains an alkaline agent as the component (D).

When adding the alkaline agent (D) to the detergent composition according to the present invention, it is possible to further enhance a detergency thereof.

As the alkaline agent (D), there is used at least one compound selected from the group consisting of organic alkali compounds, and hydroxides, carbonates, phosphates and silicates of alkali metals.

Examples of the organic alkali compounds include alkanolamines, alkylamines and quaternary ammonium salts.

Examples of the hydroxides, carbonates, phosphates and silicates of alkali metals include potassium hydroxide, sodium hydroxide, potassium carbonate, sodium carbonate, potassium phosphate, sodium phosphate, a potassium silicate solution No. 1, a sodium silicate solution No. 1, a potassium silicate solution No. 2, a sodium silicate solution No. 2, potassium orthosilicate and potassium orthosilicate.

These alkaline agents may be used alone or in combination of any two or more thereof.

Of these alkaline agents (D), from the viewpoint of a good washability, preferred are alkanolamines, and more preferred are alkanolamines represented by the following formula (3):

N(R⁵)(R⁶)(R⁷) (3)

wherein R⁵ is a hydrocarbon group having not less than 1 and not more than 8 carbon atoms which contains not less than 1 and not more than 3 OH groups; and R⁶ and R⁷ are each independently a hydrogen atom, an alkyl group having not less than 1 and not more than 4 carbon atoms, or an alkanol group having not less than 1 and not more than 4 carbon atoms.

In the formula (3), from the viewpoint of a good detergency, R⁵ is preferably an alkanol group having not less than 2 and not more than 4 carbon atoms, and R⁶ and R⁷ are each preferably a hydrogen atom.

Examples of the alkanolamines represented by the above formula (3) include monoethanolamine, monopropanolamine, monoisopropanolamine, diethanolamine, triethanolamine, N-methyl propanolamine, N-dimethyl ethanolamine, 2-amino-2-methyl-1-propanol and trishydroxyaminomethane.

These alkanolamines may be used alone or in combination of any two or more thereof.

Of these alkanolamines as the alkaline agent (D), from the viewpoint of a good detergency, preferred is at least one compound selected from the group consisting of monoethanolamine, monopropanolamine, monoisopropanolamine and trishydroxyaminomethane, and more preferred is monoethanolamine.

The content of the alkaline agent (D) in the detergent composition according to the present invention is preferably not less than 1% by mass, more preferably not less than 2% by mass and still more preferably not less than 5% by mass, and is also preferably not more than 30% by mass, more preferably not more than 20% by mass and still more preferably not more than 15% by mass from the viewpoint of a good detergency of the detergent composition.

### <Chelate Agent (E)>

The detergent composition according to the present invention preferably contains a chelate agent (sequestering agent) as the component (E). When compounding the chelate agent in the detergent composition, it is possible to efficiently wash off protein stains bonded and adhered to the medical devices by the action of alkali earth metal ions or alkali earth metal salts.

Examples of the chelate agent (E) include aminopolyacetic acids, organic acids, phosphonic acids, phosphoric acids, polycarboxylic acids, and salts of these acids. Specific examples of the chelate agent (E) include aminopolyacetic acids such as nitrilotriacetic acid, iminodiacetic acid, ethylenediaminetetraacetic acid (EDTA), diethylenetriaminepentaacetic acid, glycoletherdiaminetetraacetic acid, hydroxyethyliminodiacetic acid, triethylenetetraminehexaacetic acid and djenkolic acid, or salts thereof; organic acids such as diglycolic acid, oxydisuccinic acid, carboxymethyloxysuccinic acid, citric acid, lactic acid, tartaric acid, oxalic acid, malic acid, gluconic acid, carboxymethylsuccinic acid, carboxymethyl tartaric acid and glutamic acid diacetic acid, or salts thereof; phosphonic acids such as aminotri(methylenephosphonic acid), 1-hydroxyethylidene-1,1-diphosphonic acid, ethylenediaminetetra(methylenephosphonic acid) and diethylenetriaminepenta(methylenephosphonic acid), or salts thereof; phosphoric acids such as tripolyphosphoric acid, or salts thereof; and polycarboxylic acids such as polyacrylic acid and polymethacrylic acid, or salts thereof.

These chelate agents may be used alone or in combination of any two or more thereof.

Of these chelate agents (E), from the viewpoint of a good versatility, preferred is at least one compound selected from the group consisting of aminopolyacetic acids and salts thereof, and more preferred is at least one compound selected from the group consisting of ethylenediaminetetraacetic acid (EDTA) and salts thereof.

Examples of the salts of the above acids as the chelate agent (D) include alkali metal salts, quaternary ammonium salts and alkanolamine salts. From the viewpoint of a good corrosion resistance to medical devices, of these salts, preferred are alkanolamine salts, and more preferred are monoethanolamine salts.

The content of the chelate agent (E) in the detergent composition according to the present invention is preferably not less than 1% by mass, more preferably not less than 3% by mass, still more preferably not less than 5% by mass and even still more preferably not less than 10% by mass, and is also preferably not more than 50% by mass, more preferably not more than 40% by mass, still more preferably not more than 30% by mass and even still more preferably not more than 25% by mass, from the viewpoints of a good effect of removing protein stains and low costs. The content of the chelate agent (E) is calculated in terms of an acid.

<pH>

The pH value of the detergent composition according to the present invention as measured at 25° C. is preferably not less than 10, more preferably not less than 10.5 and still more preferably not less than 11 from the viewpoint of a good washability, and is also preferably not more than 13, more preferably not more than 12.5 and still more preferably not more than 12 from the viewpoint of suppressing damage to a base material of the medical devices.

The detergent composition according to the present invention may be directly used as such, but may be usually used in the form of a washing solution prepared by diluting the detergent composition with water. The dilution ratio of the washing solution from the detergent composition according to the present invention is not particularly limited, and is generally preferably not less than about 50 times by mass and not more than about 1000 times by mass.

In order to attain a high detergency, the pH value of the washing solution upon washing is also important. The pH value of a dilute washing solution prepared by diluting the detergent composition according to the present invention 200 times by mass with water as measured at 25° C. is preferably not less than 9.5, more preferably not less than 10 and still more preferably not less than 10.5 from the viewpoint of a good washability, and is also preferably not more than 12 from the viewpoint of suppressing damage to a base material of the medical devices.

### <Protease>

The detergent composition according to the present invention may contain a protease. When compounding the protease in the detergent composition, it is possible to efficiently wash off protein stains adhered to the medical devices. Although the protease may be compounded in the detergent composition according to the present invention, a protease-containing detergent composition may be used in combination with the detergent composition according to the present invention. From the viewpoint of a good enzyme stability, it is preferred that the protease-containing detergent composition separately prepared is combined with the detergent composition according to the present invention immediately before washing or upon washing.

The protease may be any enzyme belonging to protease (alkaline protease) as long as it has an optimum pH value that preferably lies in the range of from a neutral to an alkaline side. In addition, any two or more proteases capable of satisfying the above requirement may also be used in combination with each other.

The alkaline protease that may be used in combination with the detergent composition according to the present invention is preferably subtilisin protease derived from Bacillus sp., in particular, subtilisin protease derived from Bacillus Halodurans or Bacillus clausii. Examples of commercially available products of the alkaline protease include “KAP” available from Kao Corp., “Alcalase”, “Savinase”, “Everlase”, “Esperlase”, “Kannase” and “Ovozyme” all available from Novozymes Japan, Inc., and “Purafect” and “Properase” both available from Genencor International Inc. In addition, those proteases described in JP 2007-61101A may also be suitably used.

The detergent composition according to the present invention is preferably used in the form of a dilute washing solution for washing medical devices. The content (proteolytic activity) of the alkaline protease in the dilute washing solution used in the present invention is preferably not less than 0.01 PU, more preferably not less than 0.05 PU, still more preferably not less than 0.1 PU and even still more preferably not less than 0.5 PU per 1 L of the dilute washing solution, and is also preferably not more than 200 PU, more preferably not more than 100 PU, still more preferably not more than 50 PU and even still more preferably not more than 20 PU per 1 L of the dilute washing solution, from the viewpoints of a good effect of removing protein stains adhered and low costs.

Meanwhile, the proteolytic activity (PU/L) of the (dilute) washing solution may be measured by the following method.

That is, 1 mL of a 50 mmol/L borate buffer solution (pH: 10.5) containing casein (Hammerstein grade; available from Merk) at a concentration of 1 w/v % is mixed with 0.1 mL of the (dilute) washing solution to conduct a reaction therebetween at 30° C. for 15 min (the resulting reaction solution is hereinafter referred to as a “reaction solution (R)”). Then, 2 mL of a quenching solution (containing 0.11 mol/L of trichloroacetic acid, 0.22 mol/L of sodium acetate and 0.33 mol/L of acetic acid) is added to 1.1 mL of the reaction solution (R), and the resulting mixed solution is allowed to stand at room temperature (25° C.) for 10 min. Next, the acid-modified protein is removed by filtration from the solution (using a filter paper No. 2 available from Whatman Inc.), and 2.5 mL of an alkaline copper solution [1 w/v % potassium/sodium tartrate aqueous solution: 1 w/v % copper sulfate aqueous solution: sodium hydroxide aqueous solution in which 0.1 mol/L of sodium carbonate is dissolved (concentration of sodium carbonate: 2 w/v %)=1:1:100 (v/v)] is added to the resulting filtrate. A dilute phenol reagent is added to the obtained reaction solution, and after holding the solution under heating for 30 min, the resulting solution is measured for an absorbance thereof at a wavelength of 660 nm (absorbance (S)). Similarly, a blank solution (solution prepared by mixing 2.5 mL of the quenching solution in 1.1 mL of the reaction solution (R) and then adding 0.1 mL of the (dilute) washing solution to the obtained mixed solution) is measured for an absorbance thereof (absorbance (B)) at a wavelength of 660 nm to calculate an absorbance difference (absorbance (S)−absorbance (B)) from which an amount (P) of an acid-soluble protein as degradation product liberated is calculated (an amount of the product in terms of tyrosine is also calculated from a calibration curve separately prepared using tyrosine). The obtained amount (P) of the protein as degradation product is divided by the reaction time (15 min) and the amount of the (dilute) washing solution (0.1 mL) to obtain a proteolytic activity of the washing solution. Meanwhile, in the present invention, “1 PU” means an amount of an enzyme capable of liberating the acid-soluble protein as degradation product in an amount corresponding to 1 mmol of tyrosine for 1 min under the above reaction conditions. On the basis of the proteolytic activity obtained by this method, an amount of protease to be compounded in the detergent composition is determined.

The detergent composition according to the present invention may also contain a nonionic surfactant other than the component (A), an anionic surfactant other than the compound (B), a cationic surfactant other than the component (C), an amphoteric surfactant, a solvent, a hydrotropic agent, a dispersant, an antioxidant, a foam suppressor, a pH controller, a thickening agent, a viscosity modifier, a perfume, a colorant, an antiseptic agent, a bleaching agent, a bleaching activator or the like, unless the aimed effects of the present invention are adversely affected. These components may be respectively compounded in a washing solution prepared by diluting the detergent composition.

Examples of the solvent include monovalent alcohols such as ethanol and propanol; and glycol ethers such as ethylene glycol ethyl ether, propylene glycol ethyl ether, ethylene glycol butyl ether and diethylene glycol butyl ether.

Examples of the hydrotropic agent include p-toluenesulfonic acid, benzoic acid, xylenesulfonic acid and salts of these acids, as well as urea, etc.

Examples of the dispersant include polyvinyl pyrrolidone, etc.

Examples of the antioxidant include butylhydroxytoluene, sodium sulfite and sodium hydrogen sulfite.

Examples of the foam suppressor include C₈ to C₁₈ alkyl ethers of a polypropylene glycol having an average molecular weight of not less than 500 and not more than 10000 or a polypropylene glycol having an average molar number of addition of propylene glycol units of not less than 1 and not more than 10, silicone oils and silica.

Examples of the pH controller include citric acid, glycolic acid, malic acid, succinic acid and acetic acid.

### [Method of Washing Medical Device Using Washer for Medical Devices]

The method of washing a medical device using a washer for medical devices (hereinafter also referred to as merely a “washer”) according to the present invention is a washing method using a mixture of the detergent composition of the present invention and an enzyme. Protease is preferably used as the enzyme. The protease is the same as described above.

The method of washing a medical device according to the present invention preferably includes the steps of diluting the detergent composition of the present invention not less than 50 times by mass and not more than 1000 times by mass with water to prepare a dilute washing solution, and washing the medical device using the dilute washing solution.

In the method of washing a medical device according to the present invention, the step of mixing the detergent composition of the present invention with the enzyme may be conducted either before, during or after diluting the detergent composition of the present invention. From the viewpoint of a good stability of the enzyme, the mixing step is preferably conducted during or after the diluting step, and more preferably after the diluting step.

In the step of preparing the dilute washing solution, the dilution ratio of the detergent composition according to the present invention when diluted with water is preferably not less than 50 times by mass, more preferably not less than 100 times by mass, and still more preferably not less than 200 times by mass from the viewpoints of a good washability and low costs, and is also preferably not more than 1000 times by mass, more preferably not more than 500 times by mass and still more preferably not more than 400 times by mass from the viewpoint of a good washability. Thus, from the viewpoints of a good detergency and low costs, the dilution ratio of the detergent composition according to the present invention when diluted with water is preferably not less than 50 times by mass and not more than 1000 times by mass, more preferably not less than 100 times by mass and not more than 500 times by mass, and still more preferably not less than 200 times by mass and not more than 400 times by mass.

The viscosity of the dilute washing solution prepared from the detergent composition according to the present invention is preferably not more than 10000 mPa·s, more preferably not more than 1000 mPa·s and still more preferably not more than 300 mPa·s from the viewpoint of facilitated feed of the detergent composition to an automatic washer. The viscosity of the detergent composition may be measured using a B-type viscometer.

In this case, the washing temperature (temperature of the dilute washing solution) is preferably not lower than 5° C. and more preferably not lower than 10° C., and is also preferably not higher than 50° C. and more preferably not higher than 40° C. from the viewpoint of a good washability. Thus, the washing temperature (temperature of the dilute washing solution) is preferably not lower than 5° C. and not higher than 50° C. and more preferably not lower than 10° C. and not higher than 40° C. from the viewpoint of a good washability.

Also, the washing time is preferably not less than 30 s, more preferably not less than 1 min and still more preferably not less than 3 min from the viewpoint of a good washability, and is also preferably not more than 30 min, more preferably not more than 20 min and still more preferably not more than 15 min from the viewpoint of low costs. Thus, from the viewpoints of a good washability and low costs, the washing time is preferably not less than 30 s and not more than 30 min, more preferably not less than 1 min and not more than 20 min, and still more preferably not less than 3 min and not more than 15 min.

Upon washing the medical device, in particular, an endoscope, it is preferred that the endoscope is washed using a flow of the dilute washing solution.

In the method of washing a medical device according to the present invention, it is preferred that the washer for medical devices is provided therein with a liquid section for dipping the medical device therein, and the flow of the dilute washing solution is fed from above a liquid level in the liquid section. In the washer for medical devices having the liquid section, the liquid in the liquid section is preferably circulated therethrough and reused as the dilute washing solution.

With respect to the method of washing a medical device, as the method of washing an endoscope using an endoscope washer, there are mentioned the method using injected water as described in JP 60-220032A, the method using an ultrasonic wave as described in JP 11-151198A and the like.

In these washing methods, a washing solution stored in a washing tub in which the endoscope can be dipped is injected under a high pressure over a surface of the endoscope or a cover of the washing tub from nozzles disposed above a liquid level therein to wash the endoscope, then discharging of the washing solution, rinsing and dipping in a disinfectant solution, thereby rendering the endoscope reusable.

When the nozzles from which the washing solution is injected is disposed above the liquid level, there is such a merit that the injection condition of the washing solution can be visually recognized or the cover of the washing tub can also be washed. On the other hand, there tends to arise such a concern that the washing solution is considerably foamed in the washing tub. If any clogging is caused in washing solution circulating lines or nozzles in the endoscope washer, the detergency thereof tends to be deteriorated, so that the endoscope is washed only to an insufficient extent. As a result, even though the endoscope is subsequently disinfected, fungi tend to be still survival so that a concern of nosocomial infection tends to occur. For this reason, it is very important that the injection condition of water from the nozzles can be visually recognized. On the other hand, if foaming of the washing solution is caused in the washing tub, a level sensor fitted in the washing tub tends to be erroneously actuated to stop the washing work, or foams tend to be overflowed from the washing tub, thereby causing a concern of deterioration in detergency, etc.

The detergent composition according to the present invention can be used in the above method of washing a medical device using a washer for medical devices, and is capable of washing the medical device without suffering from adverse influence by foaming when being fed to the washer for medical devices.

The method of washing a medical device according to the present invention preferably includes the step of feeding the detergent composition of the present invention and a protease preparation as an enzyme into the washer for medical devices and diluting the mixture with water to prepare a washing solution. Although the enzyme may be previously compounded in the detergent composition of the present invention, from the viewpoint of a good stability of the enzyme, it is preferred that upon washing the medical device, the separately formulated enzyme preparation is mixed with the detergent composition of the present invention and the resulting mixture is diluted with water.

The above respective materials all may be added at the same time, and are preferably added in the order of water, the detergent composition of the present invention and the enzyme preparation from the viewpoint of suppressing damage to a base material of the medical devices. The protease can exhibit its effects most effectively immediately after addition thereof, and portions where washing with the protease is most needed are portions of a base material of the medical device such as an endoscope to which protein stains are adhered. Therefore, the protease preparation is preferably added after completion of addition of the detergent composition of the present invention. In addition, the protease preparation may also be added after the medical device is washed with water and the detergent composition of the present invention for a while.

With respect to the aforementioned embodiments of the present invention, there are described the following items concerning the detergent composition for a washer for medical devices and the method of washing a medical device using a washer for medical devices.

### <Item 1>

A detergent composition for a washer for medical devices, including a nonionic surfactant (A) represented by the following formula (1) which is contained in the composition in an amount of not less than 1% by mass and not more than 40% by mass; at least one compound (B) selected from the group consisting of fatty acids having not less than 6 and not more than 10 carbon atoms and salts thereof which is contained in the composition in an amount of not less than 1% by mass and not more than 20% by mass in terms of a fatty acid; a cationic surfactant (C) represented by the following formula (2); and water,

the nonionic surfactant (A) being present in an amount of not less than 90% by mass on the basis of a total amount of whole nonionic surfactants contained in the detergent composition,

a mass ratio of the at least one compound (B) selected from the group consisting of fatty acids having not less than 6 and not more than 10 carbon atoms and salts thereof to the cationic surfactant (C) [(B)/(C)] being not less than 20 and not more than 3000, and

the detergent composition having a pH value of not less than 10 as measured at 25° C.,

RO-[(EO)ₘ/(PO)ₙ]—H (1)

wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently is a number of not less than 1 and not more than 20; and the mark “/” represents that EO and PO may be added either in a random form or in a block form, and an order of addition of EO and PO is optional, and

N⁺(R¹)(R²)(R³)(R⁴).X⁻ (2)

wherein R¹, R², R³ and R⁴ are each independently an alkyl group having not less than 1 and not more than 24 carbon atoms or a benzyl group; and X⁻ is a monovalent anion.

### <Item 2>

The detergent composition for a washer for medical devices as described in <Item 1>, wherein the number of carbon atoms in R in the formula (1) is preferably not less than 8, and is also preferably not more then 12 and more preferably not more than 10.

### <Item 3>

The detergent composition for a washer for medical devices as described in <Item 1> or <item 2>, wherein R in the formula (1) is preferably a branched-chain alkyl group having not less than 6 and not more then 18 carbon atoms, more preferably a branched-chain alkyl group having not less than 8 and not more then 12 carbon atoms, and still more preferably a branched-chain alkyl group having not less than 8 and not more then 10 carbon atoms.

### <Item 4>

The detergent composition for a washer for medical devices as described in any one of <Item 1> to <Item 3>, wherein EO in the formula (1) is preferably an ethane-1,2-diyloxy group.

### <Item 5>

The detergent composition for a washer for medical devices as described in any one of <Item 1> to <Item 4>, wherein PO in the formula (1) is preferably at least one group selected from the group consisting of a propane-1,2-diyloxy group and a propane-1,3-diyloxy group, and more preferably a propane-1,2-diyloxy group.

### <Item 6>

The detergent composition for a washer for medical devices as described in any one of <Item 1> to <Item 5>, wherein m in the formula (1) is preferably not less than 2, more preferably not less than 3, still more preferably not less than 4, even still more preferably not less than 5 and further even still more preferably not less than 5.8, and is also preferably not more than 15, more preferably not more than 10 and still more preferably not more than 9.

### <Item 7>

The detergent composition for a washer for medical devices as described in any one of <Item 1> to <Item 6>, wherein n in the formula (1) is preferably not less than 3, more preferably not less than 4, still more preferably not less than 4.5 and even still more preferably not less than 4.8, and is also preferably not more than 10, more preferably not more than 7, still more preferably not more than 6 and even still more preferably not more than 5.2.

### <Item 8>

The detergent composition for a washer for medical devices as described in any one of <Item 1> to <Item 7>, wherein EO and PO in the formula (1) are preferably in the form of a random adduct of EO and PO.

### <Item 9>

The detergent composition for a washer for medical devices as described in any one of <Item 1> to <Item 8>, wherein the nonionic surfactant (A) is present in an amount of preferably not less than 95% by mass, more preferably not less than 98% by mass, still more preferably substantially 100% by mass and even still more preferably 100% by mass on the basis of a total mass of whole nonionic surfactants contained in the detergent composition.

### <Item 10>

The detergent composition for a washer for medical devices as described in any one of <Item 1> to <Item 9>, wherein a content of the component (A) in the detergent composition is preferably not less than 2% by mass, more preferably not less than 3% by mass and still more preferably not less than 4% by mass, and is also preferably not more than 20% by mass, more preferably not more than 10% by mass, still more preferably not more than 8% by mass and even still more preferably not more than 6% by mass.

### <Item 11>

The detergent composition for a washer for medical devices as described in any one of <Item 1> to <Item 10>, wherein the at least one compound (B) selected from the group consisting of fatty acids having not less than 6 and not more than 10 carbon atoms and salts thereof is preferably at least one compound selected from the group consisting of a linear-chain fatty acid, a branched-chain fatty acid and salts of these fatty acids.

### <Item 12>

The detergent composition for a washer for medical devices as described in any one of <Item 1> to <Item 11>, wherein the number of carbon atoms in the fatty acid in the component (B) is preferably not less than 7 and more preferably not less than 8, and is also preferably not more than 9 and more preferably 9.

### <Item 13>

The detergent composition for a washer for medical devices as described in any one of <Item 1> to <Item 12>, wherein the component (B) is preferably a branched-chain fatty acid and more preferably a saturated branched-chain fatty acid.

### <Item 14>

The detergent composition for a washer for medical devices as described in any one of <Item 1> to <Item 13>, wherein the at least one compound (B) selected from the group consisting of fatty acids having not less than 6 and not more than 10 carbon atoms and salts thereof is preferably at least one compound selected from the group consisting of n-octanoic acid, isooctanoic acids, isononanoic acids and alkali metal salts of these acids, more preferably at least one compound selected from the group consisting of isooctanoic acids, isononanoic acids and sodium salts of these acids, still more preferably at least one compound selected from the group consisting of 2-ethyl hexanoic acid, 3,5,5-trimethylhexanoic acid and sodium salts of these acids, and even still more preferably at least one compound selected from the group consisting of 3,5,5-trimethylhexanoic acid and sodium salts thereof.

### <Item 15>

The detergent composition for a washer for medical devices as described in any one of <Item 1> to <Item 14>, wherein a content of the at least one compound (B) selected from the group consisting of fatty acids having not less than 6 and not more than 10 carbon atoms and salts thereof in the detergent composition is preferably not less than 2% by mass, more preferably not less than 3% by mass and still more preferably not less than 5% by mass, and is also preferably not more than 15% by mass, more preferably not more than 10% by mass and still more preferably not more than 7% by mass.

### <Item 16>

The detergent composition for a washer for medical devices as described in any one of <Item 1> to <Item 15>, wherein a mass ratio of a content of the nonionic surfactant (A) to a content of the at least one compound (B) selected from the group consisting of the fatty acids and the salts thereof [(A)/(B)] is preferably not less than ⅕, more preferably not less than ⅓, still more preferably not less than 3/7, even still more preferably not less than ½ and further even still more preferably not less than 0.8, and is also preferably not more than 5, more preferably not more than 3, still more preferably not more than 2, even still more preferably not more than 1.4 and further even still more preferably not more than 1.2.

### <Item 17>

The detergent composition for a washer for medical devices as described in any one of <Item 1> to <Item 16>, wherein R¹ in the formula (2) is preferably an alkyl group having not less than 8 and not more than 16 carbon atoms.

### <Item 18>

The detergent composition for a washer for medical devices as described in any one of <Item 1> to <Item 17>, wherein R² in the formula (2) is preferably an alkyl group having not less than 8 and not more than 16 carbon atoms or an alkyl group having not less than 1 and not more than 3 carbon atoms.

### <Item 19>

The detergent composition for a washer for medical devices as described in any one of <Item 1> to <Item 18>, wherein R³ in the formula (2) is preferably an alkyl group having not less than 1 and not more than 3 carbon atoms or a benzyl group.

### <Item 20>

The detergent composition for a washer for medical devices as described in any one of <Item 1> to <Item 19>, wherein R⁴ in the formula (2) is preferably an alkyl group having not less than 1 and not more than 3 carbon atoms or a benzyl group.

### <Item 21>

The detergent composition for a washer for medical devices as described in any one of <Item 1> to <Item 20>, wherein X⁻ in the formula (2) is preferably at least one ion selected from the group consisting of a hydroxide ion, halide ions, an acetate ion, a formate ion, a nitrate ion and a hydrogen carbonate ion, more preferably at least one ion selected from the group consisting of a hydroxide ion and halide ions, still more preferably at least one ion selected from the group consisting of halide ions, and even still more preferably at least one ion selected from the group consisting of chloride ions.

### <Item 22>

The detergent composition for a washer for medical devices as described in <Item 21>, wherein the halide ion is at least one ion selected from the group consisting of a fluoride ion, a chloride ion, a bromide ion and an iodide ion, and more preferably a chloride ion.

### <Item 23>

The detergent composition for a washer for medical devices as described in any one of <Item 1> to <Item 22>, wherein the cationic surfactant (C) represented by the formula (2) is preferably at least one compound selected from the group consisting of alkyl dimethyl benzyl ammonium halides, alkyl trimethyl ammonium halides, dialkyl dimethyl ammonium halides, alkyl pyridinium chlorides and tetraalkyl ammonium chlorides, more preferably at least one compound selected from the group consisting of alkyl dimethyl benzyl ammonium halides, still more preferably at least one compound selected from the group consisting of alkyl dimethyl benzyl ammonium chlorides, and even still more preferably at least one compound selected from the group consisting of dodecyl dimethyl benzyl ammonium chloride, tetradecyl dimethyl benzyl ammonium chloride and hexadecyl dimethyl benzyl ammonium chloride.

### <Item 24>

The detergent composition for a washer for medical devices as described in any one of <Item 1> to <Item 23>, wherein a content of the cationic surfactant (C) represented by the formula (2) in the detergent composition is preferably not less than 0.0015% by mass, more preferably not less than 0.002% by mass, still more preferably not less than 0.0025% by mass, even still more preferably not less than 0.005% by mass and further even still more preferably not less than 0.01% by mass, and is also preferably not more than 0.3% by mass, more preferably not more than 0.2% by mass, still more preferably not more than 0.1% by mass, even still more preferably not more than 0.05% by mass and further even still more preferably not more than 0.03% by mass.

### <Item 25>

The detergent composition for a washer for medical devices as described in any one of <Item 1> to <Item 24>, wherein a mass ratio of a content of the at least one compound (B) selected from the group consisting of fatty acids having not less than 6 and not more than 10 carbon atoms and salts thereof to a content of the cationic surfactant (C) [(B)/(C)] is preferably not less than 25, more preferably not less than 30, still more preferably not less than 50, even still more preferably not less than 100, further even still more preferably not less than 170 and further even still more preferably not less than 200, and is also preferably not more than 2500, more preferably not more than 2000, still more preferably not more than 1000 and even still more preferably not more than 500.

### <Item 26>

The detergent composition for a washer for medical devices as described in any one of <Item 1> to <Item 25>, wherein a mass ratio of a content of the nonionic surfactant (A) to a content of the cationic surfactant (C) [(A)/(C)] is preferably not less than 20, more preferably not less than 25, still more preferably not less than 30, even still more preferably not less than 50, further even still more preferably not less than 100, further even still more preferably not less than 170 and further even still more preferably not less than 200, and is also preferably not more than 3000, more preferably not more than 2500, still more preferably not more than 2000, even still more preferably not more than 1000 and further even still more preferably not more than 500.

### <Item 27>

The detergent composition for a washer for medical devices as described in any one of <Item 1> to <Item 26>, wherein a hardness of the water is preferably not more than 200 ppm, and more preferably not more than 100 ppm.

### <Item 28>

The detergent composition for a washer for medical devices as described in any one of <Item 1> to <Item 27>, preferably further including an alkaline agent (D).

### <Item 29>

The detergent composition for a washer for medical devices as described in <Item 28>, wherein the alkaline agent (D) is preferably an alkanolamine, and more preferably an alkanolamine represented by the following formula (3),

N(R⁵)(R⁶)(R⁷) (3)

wherein R⁵ is a hydrocarbon group having not less than 1 and not more than 8 carbon atoms which contains not less than 1 and not more than 3 OH groups; and R⁶ and R⁷ are each independently a hydrogen atom, an alkyl group having not less than 1 and not more than 4 carbon atoms, or an alkanol group having not less than 1 and not more than 4 carbon atoms.

### <Item 30>

The detergent composition for a washer for medical devices as described in <Item 28> or <Item 29>, wherein the alkaline agent (D) is preferably at least one compound selected from the group consisting of monoethanolamine, monopropanolamine, monoisopropanolamine, diethanolamine, triethanolamine, N-methyl propanolamine, N-dimethyl ethanolamine, 2-amino-2-methyl-1-propanol and trishydroxyaminomethane, more preferably at least one compound selected from the group consisting of monoethanolamine, monopropanolamine, monoisopropanolamine and trishydroxyaminomethane, and still more preferably monoethanolamine.

### <Item 31>

The detergent composition for a washer for medical devices as described in any one of <Item 28> to <Item 30>, wherein a content of the alkaline agent (D) in the detergent composition is preferably not less than 1% by mass, more preferably not less than 2% by mass and still more preferably not less than 5% by mass, and is also preferably not more than 30% by mass, more preferably not more than 20% by mass and still more preferably not more than 15% by mass.

### <Item 32>

The detergent composition for a washer for medical devices as described in any one of <Item 1> to <Item 31>, preferably further including a chelate agent (E).

### <Item 33>

The detergent composition for a washer for medical devices as described in <Item 32>, wherein the chelate agent (E) is preferably at least one compound selected from the group consisting of aminopolyacetic acids, organic acids, phosphonic acids, phosphoric acids, polycarboxylic acids, and salts of these acids, more preferably at least one compound selected from the group consisting of aminopolyacetic acids and salts thereof, and still more preferably at least one compound selected from the group consisting of ethylenediaminetetraacetic acid and salts thereof.

### <Item 34>

The detergent composition for a washer for medical devices as described in <Item 32> or <Item 33>, wherein a content of the chelate agent (E) in the detergent composition is preferably not less than 1% by mass, more preferably not less than 3% by mass, still more preferably not less than 5% by mass and even still more preferably not less than 10% by mass, and is also preferably not more than 50% by mass, more preferably not more than 40% by mass, still more preferably not more than 30% by mass and even still more preferably not more than 25% by mass.

### <Item 35>

The detergent composition for a washer for medical devices as described in any one of <Item 1> to <Item 34>, wherein a pH value of the detergent composition as measured at 25° C. is preferably not less than 10.5 and more preferably not less than 11, and is also preferably not more than 13, more preferably not more than 12.5 and still more preferably not more than 12.

### <Item 36>

The detergent composition for a washer for medical devices as described in any one of <Item 1> to <Item 35>, wherein a pH value of a dilute solution prepared by diluting the detergent composition 200 times by mass with water as measured at 25° C. is preferably not less than 9.5, more preferably not less than 10 and still more preferably not less than 10.5, and is also preferably not more than 12.

### <Item 37>

The detergent composition for a washer for medical devices as described in any one of <Item 1> to <Item 36>, wherein the medical device is preferably an endoscope.

### <Item 38>

A method of washing a medical device using a washer for medical devices, including the step of washing the medical device with a mixture containing the detergent composition for a washer for medical devices as described in any one of <Item 1> to <Item 37>, and an enzyme.

### <Item 39>

The method of washing a medical device using a washer for medical devices as described in <Item 38>, wherein a washing solution prepared by diluting the detergent composition for a washer for medical devices as described in any one of <Item 1> to <Item 37> preferably not less than 50 times by mass, more preferably not less than 100 times by mass and still more preferably not less than 200 times by mass, and also preferably not more than 1000 times by mass, more preferably not more than 500 times by mass and still more preferably not more than 400 times by mass, is used.

### <Item 40>

The method of washing a medical device using a washer for medical devices as described in <Item 38> or <Item 39>, wherein the enzyme is preferably a protease and more preferably an alkaline protease.

### <Item 41>

The method of washing a medical device using a washer for medical devices as described in any one of <Item 38> to <Item 40>, wherein the enzyme is the alkaline protease, and a proteolytic activity of the alkaline protease in the washing solution is preferably not less than 0.01 PU/L, more preferably not less than 0.05 PU/L, still more preferably not less than 0.1 PU/L and even still more preferably not less than 0.5 PU/L, and is also preferably not more than 200 PU/L, more preferably not more than 100 PU/L, still more preferably not more than 50 PU/L and even still more preferably not more than 20 PU/L.

### <Item 42>

The method of washing a medical device using a washer for medical devices as described in any one of <Item 38> to <Item 41>, wherein a viscosity of the dilute washing solution prepared by diluting the detergent composition for a washer for medical devices as described in any one of <Item 1> to <Item 37> as measured at 25° C. is preferably not more than 10000 mPa·s, more preferably not more than 1000 mPa·s and still more preferably not more than 300 mPa·s.

### <Item 43>

The method of washing a medical device using a washer for medical devices as described in any one of <Item 38> to <Item 42>, wherein a washing temperature used in the method is not lower than 5° C. and more preferably not lower than 10° C., and is also preferably not higher than 50° C. and more preferably not higher than 40° C.

### <Item 44>

The method of washing a medical device using a washer for medical devices as described in any one of <Item 38> to <Item 43>, wherein a washing time used in the method is preferably not less than 30 s, more preferably not less than 1 min and still more preferably not less than 3 min, and is also preferably not more than 30 min, more preferably not more than 20 min and still more preferably not more than 15 min.

### <Item 45>

The method of washing a medical device using a washer for medical devices as described in any one of <Item 38> to <Item 44>, wherein the medical device is washed while circulating the washing solution.

### <Item 46>

The method of washing a medical device using a washer for medical devices as described in any one of <Item 38> to <Item 45>, wherein the medical device is preferably an endoscope.

### <Item 47>

A use of the detergent composition for a washer for medical devices as described in any one of <Item 1> to <Item 37> as a detergent for a washer for medical devices.

### EXAMPLES

### Examples 1 to 18 and Comparative Examples 1 to 6

The detergent compositions for a washer for medical devices as shown in Table 1 to 3. were prepared, and measured for a pH value thereof and also evaluated for a foam-suppressing property, a washability and a storage stability thereof by the following methods. The results are shown in Tables 1 to 3.

### (0) Measurement of pH

The pH value was measured at a temperature of 25° C. using a pH meter “F-21” available from Horiba Ltd.

(1-1) Evaluation of Foam-Suppressing Property (without Addition of “OLDAMIN”)

The foam-suppressing property was evaluated using an endoscope washing/disinfecting device “OER-2” available from Olympus Medical Systems Corp. That is, 50 mL of the detergent composition (20° C.) was charged together with 10 L of tap water (hardness: 30 ppm) cooled to 5° C. into a washing tub of the device at the same time. The washing time of the device was set to 10 min, and the device was operated to evaluate a foaming state in the device after 10 min according to the following evaluation criteria.

### [Evaluation Criteria]

4: Less foaming was caused, no rise of a level of a washing solution was observed, and no problem concerning operation of the washer occurred.

3: Much foaming was caused, slight raise of a level of a washing solution was observed but no problem concerning operation of the washer occurred.

2: Violent foaming was caused, rise of a level of a washing solution was observed, and when washed for a long period of time (5 min or longer), foams were overflowed in some cases, and further the foaming caused deterioration in washability owing to decrease in water pressure and scattering of ultrasonic wave.

1: Considerable foaming was caused, and the device was no longer usable owing to leakage of a large amount of a washing solution.

The detergent composition having Rank 3 or 4 is acceptable, and usable as a detergent composition for a washer for medical devices.

(1-2) Evaluation of Amount of Foams (without Addition of “OLDAMIN”)

A transparent glass cylindrical container (inner diameter: 60 mm; height: 600 mm) capable of visually observing the condition of contents therein was charged with 500 mL of tap water (hardness: 30 ppm) cooled to 5° C. and further with 2.5 mL of the detergent composition (20° C.) to prepare a washing solution. Using a tubing pump “Masterflex L/S” available from Cole Parmer Instruments Co., Ltd., the washing solution in the cylindrical container was sucked up at a flow rate of 1.5 L/min and fed to a nozzle, and then injected from the nozzle onto a level surface of the washing solution in the cylindrical container in the direction perpendicular to the level surface, thereby circulating the washing solution. The nozzle had an inner diameter of 2 mm, and was disposed such that a tip end thereof was located 25 cm above the level surface of the washing solution in the cylindrical container. The washing solution was injected from the nozzle in the form of a bar-like flow.

The washing solution was circulated for 2 min, and then allowed to stand for 1 min. Thereafter, the amount of foams remaining in the cylindrical container was read out from graduations marked at the intervals of 10 mL on the cylindrical container.

(2-1) Evaluation of Foam-Suppressing Property (with Addition of “OLDAMIN”)

In the above evaluation (1-1) of a foam-suppressing property (without addition of “OLDAMIN”), 10 μL of “OLDAMIN FOR INJECTION” was added together with the detergent composition to the washing solution to evaluate a foaming condition thereof by the same method as described in the above evaluation (1-1).

(2-2) Evaluation of Amount of Foams (with Addition of “OLDAMIN”)

“OLDAMIN FOR INJECTION” was diluted 20 times with ion-exchanged water, and 10 μL of the resulting dilute solution of “OLDAMIN FOR INJECTION” was further added to the washing solution used in the above evaluation (1-2) to measure an amount of foams therein by the same method as described in the above evaluation (1-2).

### (3) Evaluation of Washability

Model stains containing water, glycerin, serum, mucin, wheat flour and safranin as described in EN/ISO15883-5 Annex R were applied in an amount of 10 mg/cm² onto a 16 mm-diameter circle region of a test piece (3 cm×8 cm×1 mm in thickness) made of Teflon (registered trademark), and dried at room temperature for 1 h. The thus stained test piece was used for the following experiment.

The stained test piece was fixed in an endoscope washing/disinfecting device “OER-2” available from Olympus Medical Systems Corp., and 10 L of tap water (hardness: 30 ppm) cooled to 5° C. was charged into a washing tub of the device. Immediately after initiation of the washing operation, 50 mL of the detergent composition for a washer for medical devices and 5 mL of “Savinase” (available from Novozymes Japan, Inc.; protease; enzymatic activity: 12 PU/mL) were directly charged into the washing tub. The concentration of the detergent composition for a washer for medical devices in the washing solution was 0.5% by mass, and the concentration of “Savinase” in the washing solution was 0.05% by mass. After the elapse of 10 min from the initiation of the washing operation, the operation of the device was stopped to discharge the washing water therefrom. Then, the test piece was taken out from the device and moderately rinsed with 1000 mL of ion-exchanged water at 20° C. in a separately provided water vessel. After drying, the test piece was observed by naked eyes to examine whether or not any stains remained thereon (pre-CBB dyeing judgment). Thereafter, the test piece on which no remaining stains were observed by naked eyes was dipped in a Coomassie Protein Assay Reagent (reagent attached to a protein determination kit available from Thermo Scientific K.K.) for 3 min and subjected to CBB dyeing. The dyed test piece was fully rinsed with ion-exchanged water, and the dyeing condition thereof was observed to examine whether or not a trace amount of stains still remained thereon (post-CBB dyeing judgment). The judgments were carried out according to the following evaluation criteria.

### [Evaluation Criteria]

5: In any of the judgments before and after CBB dyeing, no remaining stains were recognized.

4: In the judgment before CBB dyeing, no remaining stains were recognized, but in the judgment after CBB dyeing, remaining protein stains having a size of not more than 0.5 cm² were partially recognized.

3: In the judgment before CBB dyeing, no remaining stains were recognized, but in the judgment after CBB dyeing, remaining protein stains were recognized on a whole test surface of the test piece.

2: Even in the judgment before CBB dyeing, a slight amount of remaining stains were recognized.

1: In the judgment before CBB dyeing, a large amount of remaining blood stains were recognized.

Rank 4 or 5 was acceptable without any practical problem for reuse, i.e., it was recognized that the test piece was well washed.

### (4) Evaluation of Storage Stability

The detergent composition for a washer for medical devices was placed in a transparent glass container and stored in a constant-temperature oven at 50° C. for one day. Thereafter, the detergent composition was observed by naked eyes to examine an appearance thereof, and evaluated according to the following evaluation criteria.

### [Evaluation Criteria]

A: Transparent and uniform; and

B: Separated into two layers, or precipitates were produced.

TABLE 1
1

| | Examples | | | | |
|---|---|---|---|---|---|
| | 1 | 2 | 3 | 4 | 5 |
| Detergent composition (mass %) | | | | | |
| Component (A) | | | | | |
| Nonionic surfactant 1 | 5 | 5 | 5 | 5 | 5 |
| Nonionic surfactant 2 | — | — | — | — | — |
| Component (A′) | | | | | |
| Nonionic surfactant 3 | — | — | — | — | — |
| Compound (B) | | | | | |
| Trimethylhexanoic acid (branched chain: C9) | 5 | — | — | 5 | 5 |
| Caprylic acid (linear chain: C8) | — | 5 | — | — | — |
| 2-Ethylhexanoic acid (branched chain: C8) | — | — | 5 | — | — |
| 5-Methylhexanoic acid (branched chain: C7) | — | — | — | — | — |
| Component (C) | | | | | |
| Alkyl dimethyl benzyl ammonium chloride | 0.02 | 0.02 | 0.02 | 0.005 | 0.2 |
| Lauryl trimethyl ammonium chloride | — | — | — | — | — |
| Cetyl trimethyl ammonium chloride | — | — | — | — | — |
| Dioctyl dimethyl ammonium chloride | — | — | — | — | — |
| Component (C′) | | | | | |
| Benzethonium chloride | — | — | — | — | — |
| Chlorhexidine gluconate | — | — | — | — | — |
| Component (D) | | | | | |
| MEA | 10 | 10 | 10 | 10 | 10 |
| Component (E) | | | | | |
| EDTA•4Na | 20 | 20 | 20 | 20 | 20 |
| Ion-exchanged water | Balance | | | | |
| Total (mass %) | 100 | 100 | 100 | 100 | 100 |
| Content of component (A) | 100 | 100 | 100 | 100 | 100 |
| in nonionic surfactants (mass %) | | | | | |
| Mass ratio [(B)/(C)] | 250 | 250 | 250 | 1000 | 25 |
| Mass ratio [(A)/(B)] | 1 | 1 | 1 | 1 | 1 |
| pH (25° C.) | 11.7 | 11.6 | 11.6 | 11.7 | 11.7 |
| Evaluation | | | | | |
| (1-1) Foam-suppressing property | 4 | 4 | 4 | 4 | 3 |
| (without addition of “OLDAMIN”) | | | | | |
| (1-2) Amount of foams | 60 | 80 | 70 | 80 | 180 |
| (without addition of “OLDAMIN”) (mL) | | | | | |
| (2-1) Foam-suppressing property | 4 | 4 | 4 | 4 | 3 |
| (with addition of “OLDAMIN”) | | | | | |
| (2-2) Amount of foams | 40 | 60 | 50 | 70 | 130 |
| (with addition of “OLDAMIN”) (mL) | | | | | |
| (3) Washability | 5 | 5 | 5 | 5 | 4 |
| (4) Storage stability | A | A | A | A | A |

2

| | Examples | | | | |
|---|---|---|---|---|---|
| | 6 | 7 | 8 | 9 | 10 |
| Detergent composition (mass %) | | | | | |
| Component (A) | | | | | |
| Nonionic surfactant 1 | 5 | 5 | 5 | 3 | 7 |
| Nonionic surfactant 2 | — | — | — | — | — |
| Component (A′) | | | | | |
| Nonionic surfactant 3 | — | — | — | — | — |
| Compound (B) | | | | | |
| Trimethylhexanoic acid (branched chain: C9) | 5 | 5 | 5 | — | 5 |
| Caprylic acid (linear chain: C8) | — | — | — | 7 | — |
| 2-Ethylhexanoic acid (branched chain: C8) | — | — | — | — | — |
| 5-Methylhexanoic acid (branched chain: C7) | — | — | — | — | — |
| Component (C) | | | | | |
| Alkyl dimethyl benzyl ammonium chloride | — | — | — | 0.02 | 0.02 |
| Lauryl trimethyl ammonium chloride | 0.02 | — | — | — | — |
| Cetyl trimethyl ammonium chloride | — | 0.02 | — | — | — |
| Dioctyl dimethyl ammonium chloride | — | — | 0.02 | — | — |
| Component (C′) | | | | | |
| Benzethonium chloride | — | — | — | — | — |
| Chlorhexidine gluconate | — | — | — | — | — |
| Component (D) | | | | | |
| MEA | 10 | 10 | 10 | 10 | 8 |
| Component (E) | | | | | |
| EDTA•4Na | 20 | 20 | 20 | 20 | 15 |
| Ion-exchanged water | Balance | | | | |
| Total (mass %) | 100 | 100 | 100 | 100 | 100 |
| Content of component (A) | 100 | 100 | 100 | 100 | 100 |
| in nonionic surfactants (mass %) | | | | | |
| Mass ratio [(B)/(C)] | 250 | 250 | 250 | 350 | 250 |
| Mass ratio [(A)/(B)] | 1 | 1 | 1 | 0.43 | 1.4 |
| pH (25° C.) | 11.7 | 11.7 | 11.7 | 11.5 | 11.2 |
| Evaluation | | | | | |
| (1-1) Foam-suppressing property | 4 | 4 | 4 | 4 | 4 |
| (without addition of “OLDAMIN”) | | | | | |
| (1-2) Amount of foams | 80 | 70 | 90 | 80 | 80 |
| (without addition of “OLDAMIN”) (mL) | | | | | |
| (2-1) Foam-suppressing property | 4 | 4 | 4 | 4 | 4 |
| (with addition of “OLDAMIN”) | | | | | |
| (2-2) Amount of foams | 80 | 50 | 60 | 60 | 60 |
| (with addition of “OLDAMIN”) (mL) | | | | | |
| (3) Washability | 5 | 5 | 5 | 5 | 5 |
| (4) Storage stability | A | A | A | A | A |

TABLE 2
1

| | Examples | | | |
|---|---|---|---|---|
| | 11 | 12 | 13 | 14 |
| Detergent composition (mass %) | | | | |
| Component (A) | | | | |
| Nonionic surfactant 1 | — | 4.75 | 5 | 5 |
| Nonionic surfactant 2 | 5 | — | — | — |
| Component (A′) | | | | |
| Nonionic surfactant 3 | — | 0.25 | — | — |
| Compound (B) | | | | |
| Trimethylhexanoic acid (branched chain: C9) | 5 | 5 | 5 | 5 |
| Caprylic acid (linear chain: C8) | — | — | — | — |
| 2-Ethylhexanoic acid (branched chain: C8) | — | — | — | — |
| 5-Methylhexanoic acid (branched chain: C7) | — | — | — | — |
| Component (C) | | | | |
| Alkyl dimethyl benzyl ammonium chloride | 0.02 | 0.02 | 0.1 | 0.0025 |
| Lauryl trimethyl ammonium chloride | — | — | — | — |
| Cetyl trimethyl ammonium chloride | — | — | — | — |
| Dioctyl dimethyl ammonium chloride | — | — | — | — |
| Component (C′) | | | | |
| Benzethonium chloride | — | — | — | — |
| Chlorhexidine gluconate | — | — | — | — |
| Component (D) | | | | |
| MEA | 10 | 10 | 10 | 10 |
| Component (E) | | | | |
| EDTA•4Na | 20 | 20 | 20 | 20 |
| Ion-exchanged water | Balance | | | |
| Total (mass %) | 100 | 100 | 100 | 100 |
| Content of component (A) | 100 | 95 | 100 | 100 |
| in nonionic surfactants (mass %) | | | | |
| Mass ratio [(B)/(C)] | 250 | 250 | 50 | 2000 |
| Mass ratio [(A)/(B)] | 1 | 0.95 | 1 | 1 |
| pH (25° C.) | 11.7 | 11.7 | 11.7 | 11.7 |
| Evaluation | | | | |
| (1-1) Foam-suppressing property | 4 | 3 | 3 | 4 |
| (without addition of “OLDAMIN”) | | | | |
| (1-2) Amount of foams | 70 | 170 | 120 | 60 |
| (without addition of “OLDAMIN”) (mL) | | | | |
| (2-1) Foam-suppressing property | 4 | 4 | 4 | 4 |
| (with addition of “OLDAMIN”) | | | | |
| (2-2) Amount of foams | 50 | 80 | 80 | 80 |
| (with addition of “OLDAMIN”) (mL) | | | | |
| (3) Washability | 5 | 5 | 5 | 5 |
| (4) Storage stability | A | A | A | A |

2

| | Examples | | | |
|---|---|---|---|---|
| | 15 | 16 | 17 | 18 |
| Detergent composition (mass %) | | | | |
| Component (A) | | | | |
| Nonionic surfactant 1 | 5 | 5 | 10 | 5 |
| Nonionic surfactant 2 | — | — | — | — |
| Component (A′) | | | | |
| Nonionic surfactant 3 | — | — | — | — |
| Compound (B) | | | | |
| Trimethylhexanoic acid (branched chain: C9) | 5 | — | 5 | 10 |
| Caprylic acid (linear chain: C8) | — | — | — | — |
| 2-Ethylhexanoic acid (branched chain: C8) | — | — | — | — |
| 5-Methylhexanoic acid (branched chain: C7) | — | 5 | — | — |
| Component (C) | | | | |
| Alkyl dimethyl benzyl ammonium chloride | 0.0017 | 0.02 | 0.02 | 0.02 |
| Lauryl trimethyl ammonium chloride | — | — | — | — |
| Cetyl trimethyl ammonium chloride | — | — | — | — |
| Dioctyl dimethyl ammonium chloride | — | — | — | — |
| Component (C′) | | | | |
| Benzethonium chloride | — | — | — | — |
| Chlorhexidine gluconate | — | — | — | — |
| Component (D) | | | | |
| MEA | 10 | 10 | 10 | 10 |
| Component (E) | | | | |
| EDTA•4Na | 20 | 20 | 20 | 20 |
| Ion-exchanged water | Balance | | | |
| Total (mass %) | 100 | 100 | 100 | 100 |
| Content of component (A) | 100 | 100 | 100 | 100 |
| in nonionic surfactants (mass %) | | | | |
| Mass ratio [(B)/(C)] | 3000 | 250 | 250 | 500 |
| Mass ratio [(A)/(B)] | 1 | 1 | 2 | 0.5 |
| pH (25° C.) | 11.7 | 11.6 | 11.7 | 11.6 |
| Evaluation | | | | |
| (1-1) Foam-suppressing property | 4 | 3 | 4 | 4 |
| (without addition of “OLDAMIN”) | | | | |
| (1-2) Amount of foams | 70 | 100 | 60 | 70 |
| (without addition of “OLDAMIN”) (mL) | | | | |
| (2-1) Foam-suppressing property | 3 | 4 | 4 | 4 |
| (with addition of “OLDAMIN”) | | | | |
| (2-2) Amount of foams | 180 | 70 | 50 | 60 |
| (with addition of “OLDAMIN”) (mL) | | | | |
| (3) Washability | 5 | 5 | 5 | 5 |
| (4) Storage stability | A | A | A | A |

TABLE 3

| | Comparative Examples | | | | | |
|---|---|---|---|---|---|---|
| | 1 | 2 | 3 | 4 | 5 | 6 |
| Detergent composition (mass %) | | | | | | |
| Component (A) | | | | | | |
| Nonionic surfactant 1 | 5 | 5 | 5 | 5 | 4.25 | 2.5 |
| Nonionic surfactant 2 | — | — | — | — | — | — |
| Component (A′) | | | | | | |
| Nonionic surfactant 3 | — | — | — | — | 0.75 | 2.5 |
| Compound (B) | | | | | | |
| Trimethylhexanoic acid | 5 | 5 | 5 | 5 | 5 | 5 |
| (branched chain: C9) | | | | | | |
| Caprylic acid (linear chain: C8) | — | — | — | — | — | — |
| 2-Ethylhexanoic acid (branched chain: C8) | — | — | — | — | — | — |
| 5-Methylhexanoic acid | — | — | — | — | — | — |
| (branched chain: C7) | | | | | | |
| Component (C) | | | | | | |
| Alkyl dimethyl benzyl ammonium chloride | 0.5 | 0.001 | — | — | 0.02 | 0.02 |
| Lauryl trimethyl ammonium chloride | — | — | — | — | — | — |
| Cetyl trimethyl ammonium chloride | — | — | — | — | — | — |
| Dioctyl dimethyl ammonium chloride | — | — | — | — | — | — |
| Component (C′) | | | | | | |
| Benzethonium chloride | — | — | 0.02 | — | — | — |
| Chlorhexidine gluconate | — | — | — | 0.02 | — | — |
| Component (D) | | | | | | |
| MEA | 10 | 10 | 10 | 10 | 10 | 10 |
| Component (E) | | | | | | |
| EDTA · 4Na | 20 | 20 | 20 | 20 | 20 | 20 |
| Ion-exchanged water | Balance | | | | | |
| Total (mass %) | 100 | 100 | 100 | 100 | 100 | 100 |
| Content of component (A) | 100 | 100 | 100 | 100 | 85 | 50 |
| in nonionic surfactants (mass %) | | | | | | |
| Mass ratio [(B)/(C)] | 10 | 5000 | 250 | 250 | 250 | 250 |
| Mass ratio [(A)/(B)] | 1 | 1 | 1 | 1 | 0.8 | 0.5 |
| pH (25° C.) | 11.6 | 11.7 | 11.7 | 11.7 | 11.7 | 11.7 |
| Evaluation | | | | | | |
| (1-1) Foam-suppressing property | 1 | 4 | 3 | 3 | 1 | 1 |
| (without addition of “OLDAMIN”) | | | | | | |
| (1-2) Amount of foams | 520 | 90 | 180 | 200 | 450 | 600 |
| (without addition of “OLDAMIN”) (mL) | | | | | | |
| (2-1) Foam-suppressing property | 1 | 1 | 2 | 2 | 2 | 1 |
| (with addition of “OLDAMIN”) | | | | | | |
| (2-2) Amount of foams | 530 | 550 | 230 | 250 | 270 | 550 |
| (with addition of “OLDAMIN”) (mL) | | | | | | |
| (3) Washability | 2 | 5 | 3 | 3 | 5 | 5 |
| (4) Storage stability | B | A | A | A | A | A |

As apparently recognized from Tables 1 to 3, even when carry-over of test drugs, etc., was caused, the detergent compositions obtained in Examples 1 to 18 were excellent in foam-suppressing property, washability and storage stability as compared to those obtained in Comparative Examples 1 to 6.

The details of the compounds shown in Tables 1 to 3 are as follows.

### <Nonionic Surfactant (A)>

Nonionic surfactant 1: A nonionic surfactant (“Plurafac LF901” available from BASF Japan, Ltd.), as a compound of the formula (1) in which R is a branched-chain alkyl group having 9 carbon atoms; m is 9; n is 5.2; and EO and PO are in the form of a random adduct.
Nonionic surfactant 2: A nonionic surfactant (“Plurafac LF900” available from BASF Japan, Ltd.), as a compound of the formula (1) in which R is a branched-chain alkyl group having 9 carbon atoms; m is 5.8; n is 4.8; and EO and PO are in the form of a random adduct.
   <Nonionic Surfactant (A′) other than Component (A)>
Nonionic surfactant 3: A nonionic surfactant (tradename: “Softanol (registered trademark) EP7085” available from Nippon Shokubai Co., Ltd.), as a compound of the following formula (1′) in which R′ includes a group (sec-C 12) represented by the following formula (a) in which a sum (a+b) of the number (a) of carbon atoms in R⁸ and the number (b) of carbon atoms in R⁹ is 11, and a group (sec-C 14) represented by the following formula (a) in which the sum (a+b) is 13, and a molar ratio of the sec-C 12 to the sec-C 14 (sec-C 12/sec-C 14) is 80/20.

R′O-[(EO)ₘ/(PO)ₙ]—H (1′)

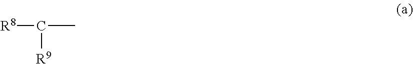

### <Fatty Acid (B)>

Trimethylhexanoic acid: 3,5,5-Trimethylhexanoic acid (branched-chain fatty acid having 9 carbon atoms)
Caprylic acid (linear-chain fatty acid having 8 carbon atoms)
2-Ethylhexanoic acid (branched-chain fatty acid having 8 carbon atoms)
5-Methyl-hexanoic acid (branched-chain fatty acid having 7 carbon atoms)

### <Cationic Surfactant (C)>

Alkyl dimethyl benzyl ammonium chloride: a cationic surfactant represented by the formula: C₆H₅CH₂N⁺(CH₃)₂R.Cl⁻ in which R is an alkyl group having an average carbon number of 14
Lauryl trimethyl ammonium chloride
Cetyl trimethyl ammonium chloride
Dioctyl trimethyl ammonium chloride
   <Cationic Surfactant (C′) other than Component (C)>
Benzethonium chloride: benzyl dimethyl chloride [2-[2-[4-(2,4,4-trimethyl pentane-2-yl)phenoxy]ethoxy]ethyl]ammonium
Chlorhexidine gluconate: gluconic acid 1-[amino-[6-[amino-[amino-(4-chlorophenyl)amino-methylidene]aminohexylimino]methyl]imino-N-(4-chlorophenyl)-methanediamine

### <Alkaline Agent (D)>

MEA: Monoethanolamine

### <Chelate Agent (E)>

EDTA.4Na: Tetrasodium ethylenediaminetetraacetate: The respective values described in Tables represent an amount in terms of the 4Na salt.

### INDUSTRIAL APPLICABILITY

The detergent composition according to the present invention can be inhibited from foaming even when carry-over of test drugs, etc., is caused upon washing a medical device using a washer for medical devices, and is excellent in washability and storage stability. The detergent composition according to the present invention is capable of effectively washing the medical device such as an endoscope when used in an automatic washer.

1. A detergent composition for a washer for medical devices, comprising a nonionic surfactant (A) represented by the formula (1) which is contained in the composition in an amount of not less than 1% by mass and not more than 40% by mass; at least one compound (B) selected from the group consisting of fatty acids having not less than 6 and not more than 10 carbon atoms and salts thereof which is contained in the composition in an amount of not less than 1% by mass and not more than 20% by mass in terms of a fatty acid; a cationic surfactant (C) represented by the formula (2); and water,
the nonionic surfactant (A) being present in an amount of not less than 90% by mass on the basis of a total amount of whole nonionic surfactants contained in the detergent composition,
a mass ratio of the at least one compound (B) selected from the group consisting of fatty acids having not less than 6 and not more than 10 carbon atoms and salts thereof to the cationic surfactant (C) [(B)/(C)] being not less than 20 and not more than 3000, and
the detergent composition having a pH value of not less than 10 as measured at 25° C.,
RO-[(EO)ₘ/(PO)ₙ]—H (1)
wherein R represents an alkyl group having not less than 6 and not more than 18 carbon atoms; EO represents an ethanediyloxy group; PO represents a propanediyloxy group; m and n each represent an average molar number of addition of the ethanediyloxy or propanediyloxy group, and are each independently a number of not less than 1 and not more than 20; and the mark “/” represents that EO and PO may be added either in a random form or in a block form, and an order of addition of EO and PO is optional, and
N⁺(R¹)(R²)(R³)(R⁴).X⁻ (2)
wherein R¹, R², R³ and R⁴ are each independently an alkyl group having not less than 1 and not more than 24 carbon atoms or a benzyl group; and X⁻ is a monovalent anion.

2. The detergent composition for a washer for medical devices according to claim 1, wherein a mass ratio of a content of the nonionic surfactant (A) to a content of the at least one compound (B) selected from the group consisting of the fatty acids and the salts thereof [(A)/(B)] is not less than ⅕ and not more than 5.

3. The detergent composition for a washer for medical devices according to claim 1, wherein R in the formula (1) is a branched-chain alkyl group having not less than 6 and not more than 18 carbon atoms.

4. The detergent composition for a washer for medical devices according to claim 1, wherein EO and PO in the formula (1) are in the form of a random adduct thereof.

5. The detergent composition for a washer for medical devices according to claim 1, wherein the cationic surfactant (C) is at least one compound selected from the group consisting of alkyl dimethyl benzyl ammonium chlorides and salts thereof.

6. The detergent composition for a washer for medical devices according to claim 1, further comprising an alkaline agent (D).

7. The detergent composition for a washer for medical devices according to claim 6, wherein the alkaline agent (D) is an alkanolamine.

8. The detergent composition for a washer for medical devices according to claim 1, further comprising a chelate agent (E).

9. The detergent composition for a washer for medical devices according to claim 1, wherein the medical device is an endoscope.

10. A method of washing a medical device using a washer for medical devices comprising the step of washing the medical device with a mixture comprising the detergent composition for a washer for medical devices as claimed in claim 1, and an enzyme.

11. A method of washing a medical device using a washer for medical devices comprising the step of washing the medical device with a mixture comprising the detergent composition for a washer for medical devices as claimed in claim 1, and an enzyme;
wherein the detergent composition for a washer for medical device is diluted with water not less than 50 times by mass and not more than 1000 times by mass upon use.

12. The method of washing a medical device using a washer for medical devices according to claim 10, wherein the enzyme is a protease.

13. The method of washing a medical device using a washer for medical devices according to claim 12, wherein the protease is an alkaline protease, and a washing solution containing the alkaline protease having a proteolytic activity of not less than 0.01 PU/L and not more than 200 PU/L is prepared and used for washing the medical device.

14. The method of washing a medical device using a washer for medical devices according to claim 13, wherein the washing solution is circulated and reused for washing the medical device.

15. The method of washing a medical device using a washer for medical devices according to claim 10, wherein the medical device is an endoscope.
